(19) United States
(12) Patent Application Publication
(10) Pub. No.: US 2005/0015934 A1
(43) Pub. Date: Jan. 27, 2005

(54) Tool handle device

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/866,489

(22) Filed: Jun. 13, 2004

(30) Foreign Application Priority Data
Jul. 21, 2003 (TW) 92119784

(51) Int. Cl. E05B 1/00

(52) U.S. Cl. 16/430

(57) ABSTRACT

A tool handle device includes a handle made of hard polymer, a cover made of soft polymer and at least one mark plate made of metal. The handle includes at least one pedestal formed thereon. The cover wraps the handle and defines at least one window through which the pedestal is visible. The mark plate is mounted on the pedestal and located within the window.

### FIELD OF INVENTION

The present invention relates to a tool handle device.

### BACKGROUND OF INVENTION

Referring to FIGS. 7 and 8, a conventional tool handle device 1 includes a handle 2 and a mark plate 4 for adhesion to the handle 2. The handle 2 is made of polymer. The mark plate 4 is made of metal. The handle 2 defines a recess 3 for receiving the mark plate 4. A gap 5 exists between the wall of the recess 3 and the mark plate 4. The gap is not pleasing aesthetically and renders it difficult to neatly locate the mark plate 4 in the recess 3.

Referring to FIGS. 9 and 10, a conventional tool handle device 6 includes a handle 7 and a cover 9. The handle 7 is made of metal. The cover 9 is made of polymer. The handle 7 defines a recess 8 for receiving the cover 9. The handle 7 is wrapped via the cover 9. A mark plate 60 is formed on the handle 7 within the recess 8. The cover 9 defines a window 62 through which the mark plate 60 is visible. As made of metal, the handle 7 made is heavy. It is difficult to fabricate the handle 7 made of metal. It is also difficult to form the mark plate 60 on the handle 7 within the recess 8.

The present invention is therefore intended to obviate or at least alleviate the problems encountered in prior art.

### SUMMARY OF INVENTION

It is the primary objective of the present invention to provide a tool handle device.

According to the present invention, a tool handle device includes a handle made of hard polymer, a cover made of soft polymer and at least one mark plate made of metal. The cover wraps the handle and defines at least one window. The mark plate is attached to the handle and located within the window.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a tool handle device according to a first embodiment of the present invention.

FIG. 2 is an exploded view of the tool handle device of FIG. 1.

FIG. 3 is a cross-sectional view taken along a line 3-3 in FIG. 4.

FIG. 4 is a cross-sectional view taken along a line 4-4 in FIG. 3.

FIG. 5 is a perspective view of a tool handle device according to a second embodiment of the present invention.

FIG. 6 is a cross-sectional view taken along a line 6-6 in FIG. 5.

FIG. 7 is a perspective view of a conventional tool handle device.

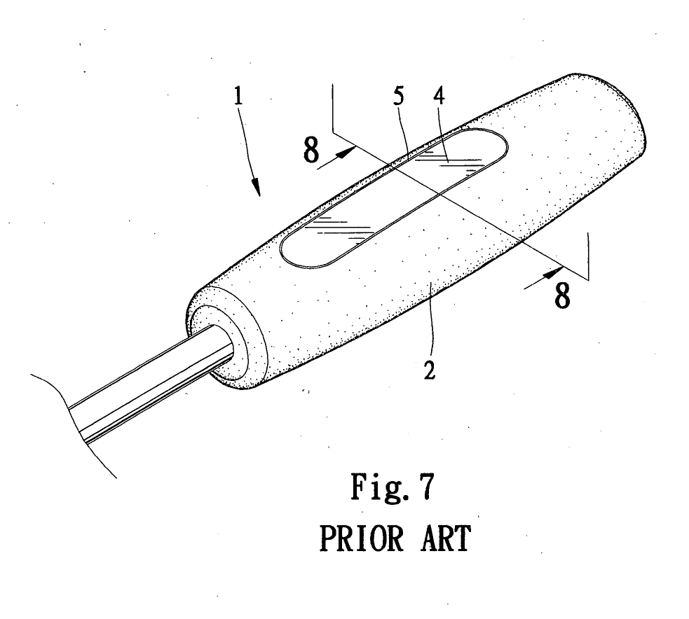

FIG. 8 is a cross-sectional view taken along a line 8-8 in FIG. 7.

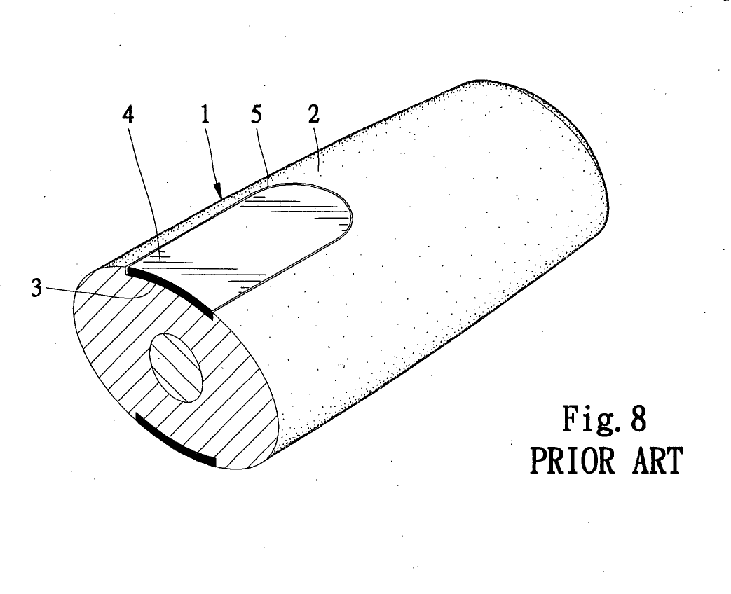

FIG. 9 is a perspective view of another conventional tool handle device.

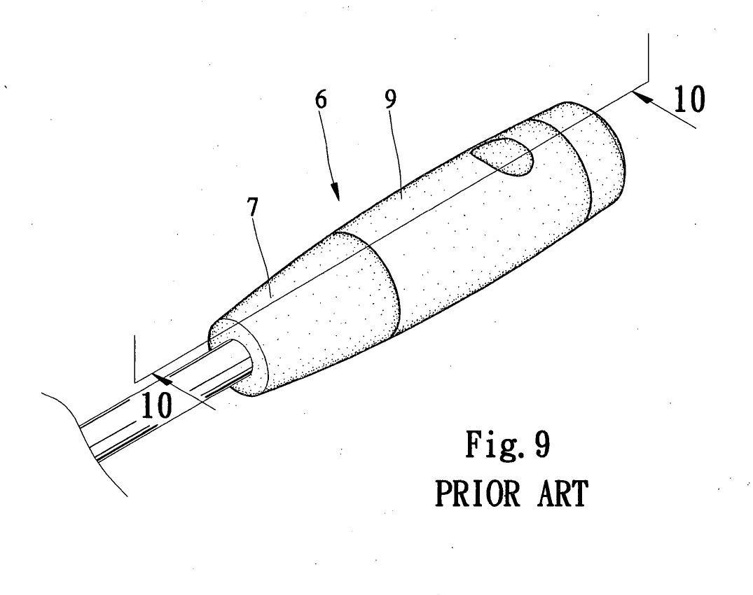

FIG. 10 is a cross-sectional view taken along a line 10-10 in FIG. 9.

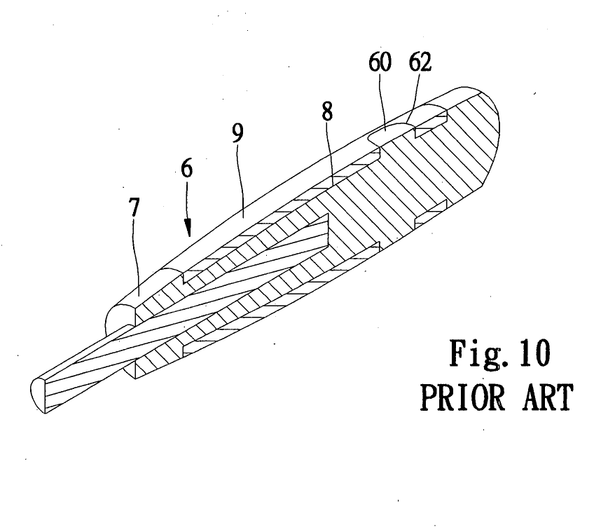

### DETAILED DESCRIPTION OF EMBODIMENTS

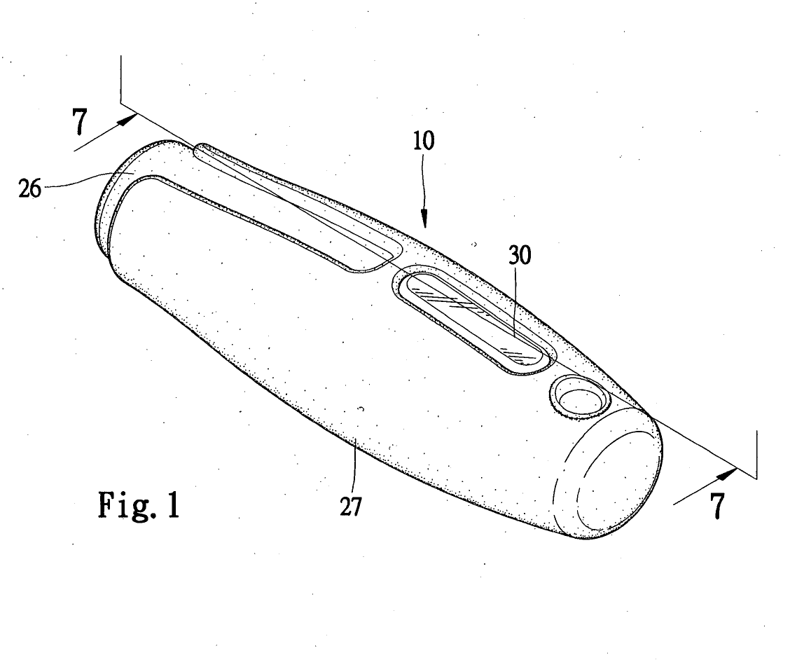

Referring to FIG. 1, according to a first embodiment of the present invention, a tool handle device 10 includes a handle 26, a cover 27 installed on and about the handle 26 and two mark plates 30 installed on the handle 26. The handle 26 is made of hard polymer, and the cover 27 of soft polymer, and the mark plates 30 of metal.

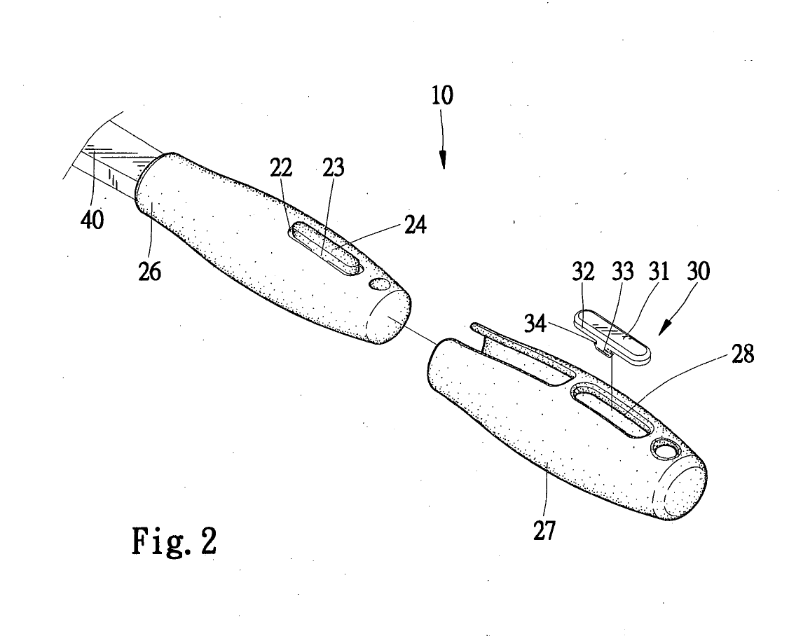

Referring to FIG. 2, the handle 26 includes two grooves 22 defined therein and two pedestals 24 formed thereon. Each of the grooves 22 extends about one of the pedestals 24. Two recesses 23 are defined in the bottom of each of the grooves 22. The handle 26 defines an axial space 25 for receiving a tool 40 (see FIG. 2).

The cover 27 defines two windows 28. Through each of the windows 28, one of the pedestals 24 is visible.

Each of the mark plates 30 includes a mark face 31 on the top, a rim 32 on the bottom about the mark face 31 and two anchors 33 extending from the rim 32. Each of the anchors 33 includes two hooks 34.

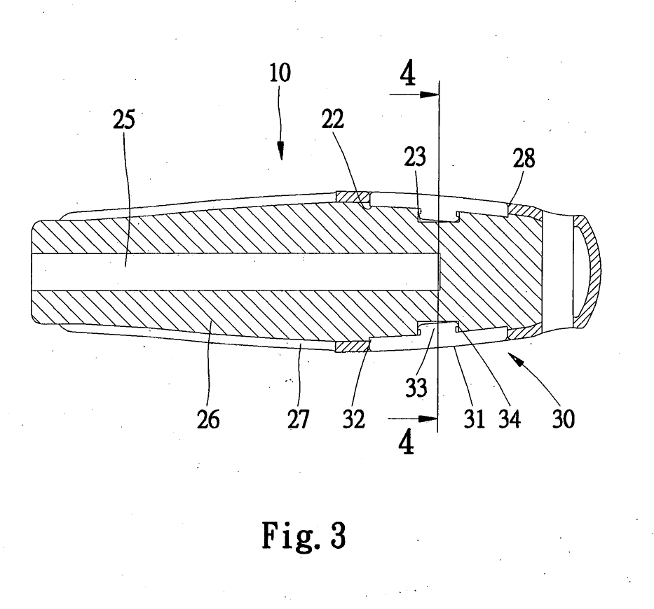

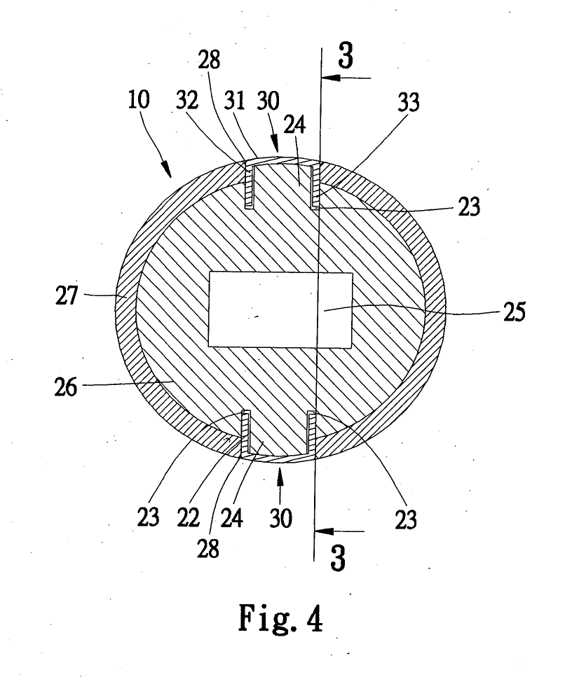

Referring to FIGS. 3 and 4, each of the mark plates 30 is put in one of the windows 28 so that it is mounted on one of the pedestals 24. The rims 32 are inserted in the grooves 22. The anchors 33 are fit in the recesses 23. As supported on the pedestals 24, the mark plates 30 will not be deformed when they are pressed. The mark face 31 of each of the mark plates 30 can be printed with a figure or word.

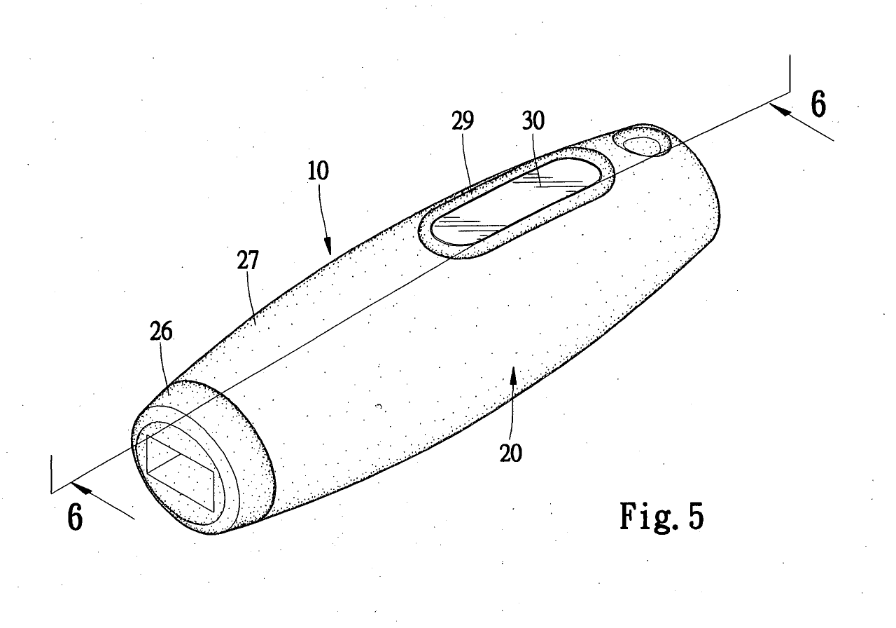

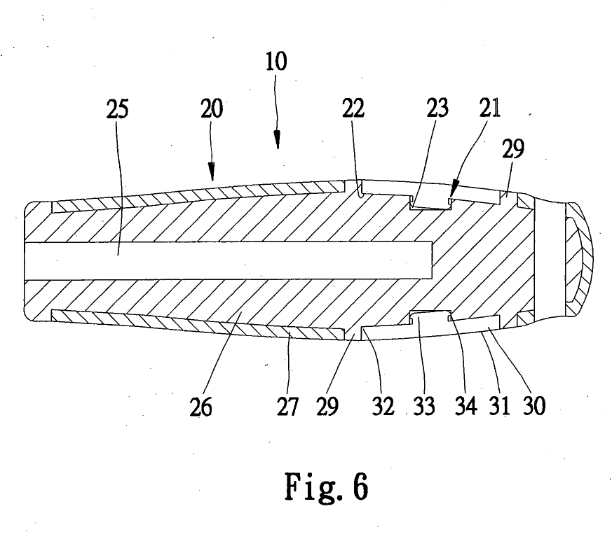

FIGS. 5 and 6 show a tool handle device according to a second embodiment of the present invention. The second embodiment is identical to the first embodiment except for including two wells 29 formed on the handle 26. Within each of the windows 28, one of the wells 29 is located. Within each of the wells 29, one of the pedestals 24 and one of the mark plates 30 is located.

The present invention has been described through detailed illustration of two embodiments. Those skilled in the art can derive variations from the embodiments without departing from the scope of the present invention. Therefore, the embodiments shall not limit the scope of the present invention defined in the claims.

1. A tool handle device including:
a handle made of hard polymer;
a cover made of soft polymer, the cover wrapping the handle and defining at least one window; and
at least one mark plate made of metal, attached to the handle and located within the window.

2. The tool handle device according to claim 1 wherein the mark plate is made of metal.

3. The tool handle device according to claim 1 wherein the mark plate includes a mark face formed thereon.

4. The tool handle device according to claim 3 wherein the mark face is printed.

5. The tool handle device according to claim 3 wherein the mark face is pressed.

6. The tool handle device according to claim 1 wherein the mark plate includes at least one anchor, and the handle defines at least one recess in which the anchor is fit.

7. The tool handle device according to claim 6 wherein the mark plate includes two anchors, and the handle defines two recesses in which the anchors are fit.

8. The tool handle device according to claim 6 wherein the anchor includes two hooks.

9. The tool handle device according to claim 1 wherein the handle defines an axial hole for receiving a tool.

10. The tool handle device according to claim 1 wherein the handle includes at least one pedestal formed thereon for supporting the mark plate within the window.

11. The tool handle device according to claim 10 wherein the handle includes two pedestals each for supporting a mark plate, wherein the cover defines two windows within which the mark plates are located.

12. The tool handle device according to claim 10 wherein the mark plate includes a rim for capping the pedestal.

13. The tool handle device according to claim 12 wherein the handle includes a groove extending about the pedestal for receiving the rim.

14. The tool handle device according to claim 12 wherein the mark plate includes at least one anchor extending from the rim, and the handle defines at least one recess in which the anchor is fit.

15. The tool handle device according to claim 14 wherein the mark plate includes two anchors, and the handle defines two recesses in which the anchors are fit.

16. The tool handle device according to claim 10 wherein the handle includes at least one well extending about the pedestal and within the window for receiving the mark plate.
